(19) United States
(12) Patent Application Publication
(10) Pub. No.: US 2014/0085278 A1
(43) Pub. Date: Mar. 27, 2014

(54) DISPLAY DEVICE

(71) Applicants: Masakazu Takeuchi, Osaka-shi (JP); Chihiro Watanabe, Osaka-shi (JP); Yasuki Mori, Osaka-shi (JP); Akihisa Iwamoto, Osaka-shi (JP)

(72) Inventors: Masakazu Takeuchi, Osaka-shi (JP); Chihiro Watanabe, Osaka-shi (JP); Yasuki Mori, Osaka-shi (JP); Akihisa Iwamoto, Osaka-shi (JP)

(73) Assignee: SHARP KABUSHIKI KAISHA, Osaka-shi, Osaka (JP)

(21) Appl. No.: 14/116,178

(22) PCT Filed: May 1, 2012
(86) PCT No.: PCT/JP2012/002952

§ 371 Date: Nov. 7, 2013

(30) Foreign Application Priority Data
May 12, 2011 (JP) 2011-107412

(51) Int. Cl. G09G 3/00

(52) U.S. Cl. CPC G09G 3/00
USPC 345/204

(57) ABSTRACT

In order to reduce the number of components forming a display device, a control IC 102 and a PC 104 are connected to an EEPROM 103 via an I2CBUS 106. The EEPROM 103 stores EDID data, and data stored in an LCD, which is used for control processing by the control IC 102.

### TECHNICAL FIELD

The present disclosure relates to display devices displaying images, etc. in response to image signals input from external devices, and more particularly to display devices which allow external devices to obtain information on the specifications, etc. of the display devices.

### BACKGROUND ART

When a display device displays an image, etc. in response to image signals input from an external device such as a personal computer, there is a need to input the image signals indicating the number of scanning lines, a scanning frequency, etc. corresponding to the specifications of the display device. A known technique stores, inside a display device, specification information (hereinafter referred to as extended display identification (EDID) data) on the specifications, etc. of the display device, and allows an external device to read the EDID data so that the external device inputs proper image signals to the display device (see, for example, Patent Document 1).

### CITATION LIST

### Patent Document

PATENT DOCUMENT 1: Japanese Unexamined Patent Publication No. 2006-189743

### SUMMARY OF THE INVENTION

### Technical Problem

However, in storing EDID data inside a display device as described above, there is a need to provide a memory element for the storage. An increase in the number of components forming the display device was a problem.

The present invention was made in view of the problem. It is an objective of the present invention to input proper image signals while reducing the number of components forming a display device.

### Solution to the Problem

In order to achieve the objective, a first aspect of the invention provides a display device performing display in response to an image signal input from an external device. The device includes a control circuit configured to control operation of the display device; and a non-volatile memory configured to store information used for processing by the control circuit. The non-volatile memory stores specification information on specifications of the display device together with the information used for the processing by the control circuit. The specification information is obtained by the external device.

As a result, the external device obtains the specification information without providing an extra non-volatile memory dedicated to the specification information, thereby easily reducing the number of the components forming the display device.

That is, a non-volatile memory, which has been conventionally accessed only by control circuits inside a display device, stores specification information, and the non-volatile memory is accessible by an external device. This does not require any non-volatile memory dedicated to storage of the specification information, thereby easily reducing the number of the components forming the display device.

According to a second aspect of the invention, in the display device of the first aspect, the non-volatile memory is connected to the control circuit, and is connectable to the external device such that the specification information stored in the non-volatile memory is read by access from the external device.

As such, the external device is directly connectable to the non-volatile memory, thereby easily obtaining the specification information stored in the non-volatile memory.

According to a third aspect of the invention, in the display device of any one of the first or second aspect of the invention, the specification information is stored in a predetermined reserved area of the non-volatile memory determined by a relation with the external device, while the information used for the processing by the control circuit is stored in an area different from the reserved area.

As a result, the external device easily obtains the specification information stored in the non-volatile memory by accessing the predetermined reserved area.

According to a fourth aspect of the invention, in the display device of any one of the first to third aspects of the invention, at least part of the specification information is used as the information used for the processing by the control circuit.

As a result, at least part of the contents stored in the non-volatile memory is shared by the external device and the control circuit, thereby reducing the amount of data stored in the non-volatile memory.

According to a fifth aspect of the invention, the display device of any one of the first to fourth aspects of the invention further includes a switch configured to selectively connect the control circuit or the external device to the non-volatile memory.

As a result, the control circuit and the external device are selectively connected to the non-volatile memory, thereby reliably preventing access competition.

According to a sixth aspect of the invention, the display device of the fifth aspect further includes an access detector configured to detect access from the external device, and control the switch to connect the external device to the non-volatile memory.

As a result, if the external device performs access, the external device is preferentially connected to the non-volatile memory so that the external device reliably obtains the specification information.

According to a seventh aspect of the invention, in the display device of the fifth aspect of the invention, switching of the switch is controlled by the control circuit.

This reliably preferentially allows the processing by the control circuit, and easily accepts access from the external device as long as it does not influence the processing.

According to an eighth aspect of the invention, the display device of the seventh aspect of the invention further includes an access detector configured to detect access from the external device. The control circuit control the switch based on a result of detection by the access detector.

This allows proper processing by the control circuit and flexible control such as reduction in the delay of a response to the access from the external device.

According to a ninth aspect of the invention, in the display device of the first aspect of the invention, the control circuit is connected to the non-volatile memory, and is connectable to the external device to obtain the specification information stored in the non-volatile memory from the external device via the control circuit.

As a result, in response to the request from the external device, the control circuit reads the specification information from the non-volatile memory and transfers the information to the external device. The external device is accessible like in the direct connection to the non-volatile memory to obtain the specification information. Thus, the non-volatile memory is used for the external device and the control circuit in common, thereby easily reducing the number of the components forming the display device.

### Advantages of the Invention

The present invention enables input of proper image signals, and reduces the number of components forming a display device.

### BRIEF DESCRIPTION OF THE DRAWINGS

FIG. 1 is a block diagram illustrating a configuration of the main part of a display device according to a first embodiment.

FIG. 2 illustrates contents stored in an EEPROM 103 according to the first embodiment.

FIG. 3 illustrates contents stored in an EEPROM 103 according to the second embodiment.

FIG. 4 is a block diagram illustrating a configuration of the main part of a display device according to a third embodiment.

FIG. 5 is a block diagram illustrating a configuration of the main part of a display device according to a fourth embodiment.

FIG. 6 is a block diagram illustrating a configuration of the main part of a display device according to a fifth embodiment.

FIG. 7 is a block diagram illustrating a configuration of the main part of a display device according to a sixth embodiment.

### DESCRIPTION OF EMBODIMENTS

Embodiment of the present invention will be described hereinafter in detail with reference to the drawings. In the following embodiments, the same reference characters as the other embodiments are used to represent elements having the same or equivalent functions, and the explanation thereof will be omitted.

### First Embodiment

A modularized liquid crystal display (LCD) device is used as an example display device in a first embodiment of the present invention.

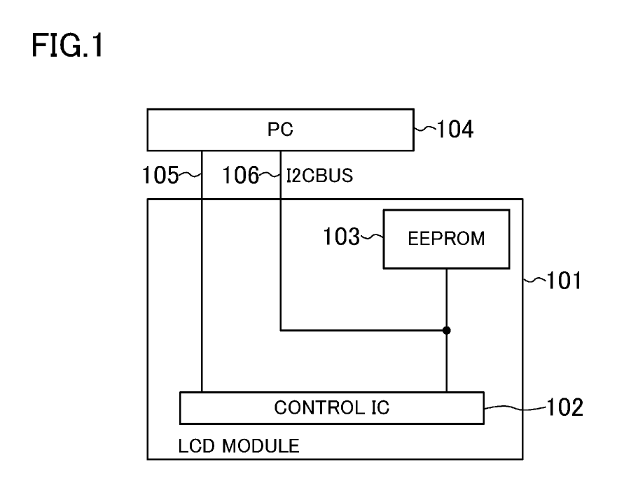

As shown in FIG. 1, an LCD module 101 includes a control IC (control circuit) 102. The control IC 102 controls the operation of the entire LCD module 101, drives a liquid crystal display panel (not shown) in response to an image signal input from a personal computer (PC) 104, which is connectable as an external device, via an image signal line 105 to display an image. The control IC 102 and the PC 104 are connected to an EEPROM (non-volatile memory) 103 via an I2CBUS 106.

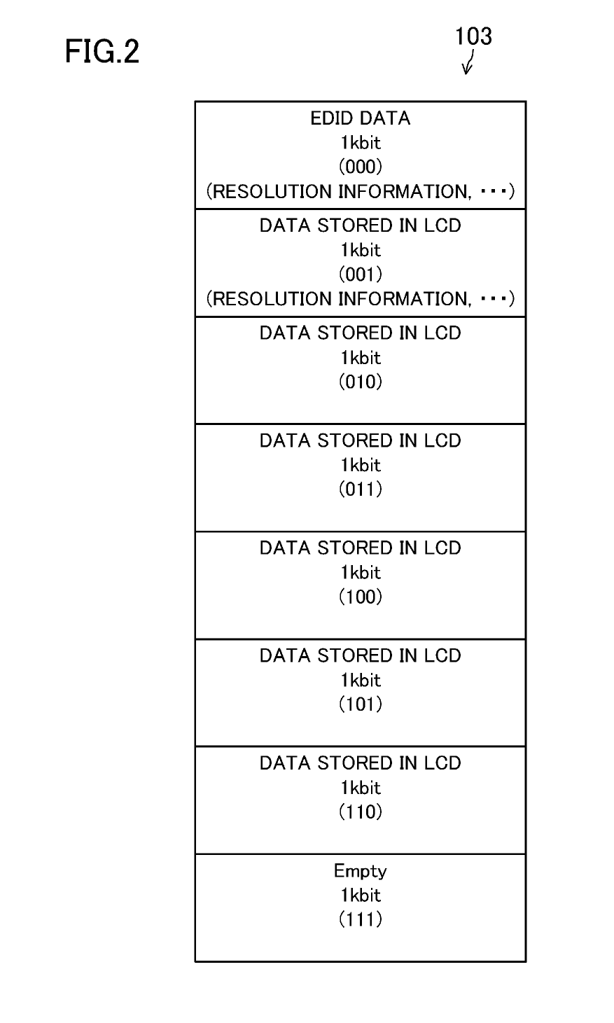

The control IC 102 performs control processing using data stored in the EEPROM 103 connected via the inter-integrated circuit bus (I2CBUS) 106. Specifically, for example, the EEPROM 103 stores data stored in an LCD such as resolution information indicating the resolution of the liquid crystal display panel in the area with addresses (001b)-(110b), where “b” represents binary-coded notation, as shown in FIG. 2. The control IC 102 refers to the data stored in the LCD, thereby generating a drive signal corresponding to the resolution, etc., and supplying the drive signal to the LCD panel.

The EEPROM 103 stores, in the area with an address (000b), i.e., the area (reserved area) of one initial kbit defined by the relation with the PC 104, for example, resolution information as EDID data, for which the PC 104 performs access via the I2CBUS 106. The PC 104 reads the resolution information, etc. and outputs an image signal corresponding to the information to the image signal line 105, thereby allowing the LCD module 101 to perform proper display.

As described above, the single EEPROM 103 includes the EDID data, for which the PC 104 performs the access, and the data stored in the LCD, which is used for control processing of the control IC 102, and the I2CBUS 106 is used in common This allows the PC 104 to obtain the EDID data via the I2CBUS 106 without providing an extra memory dedicated to the EDID data. This easily reduces the number of the components forming the LCD module 101.

### Second Embodiment

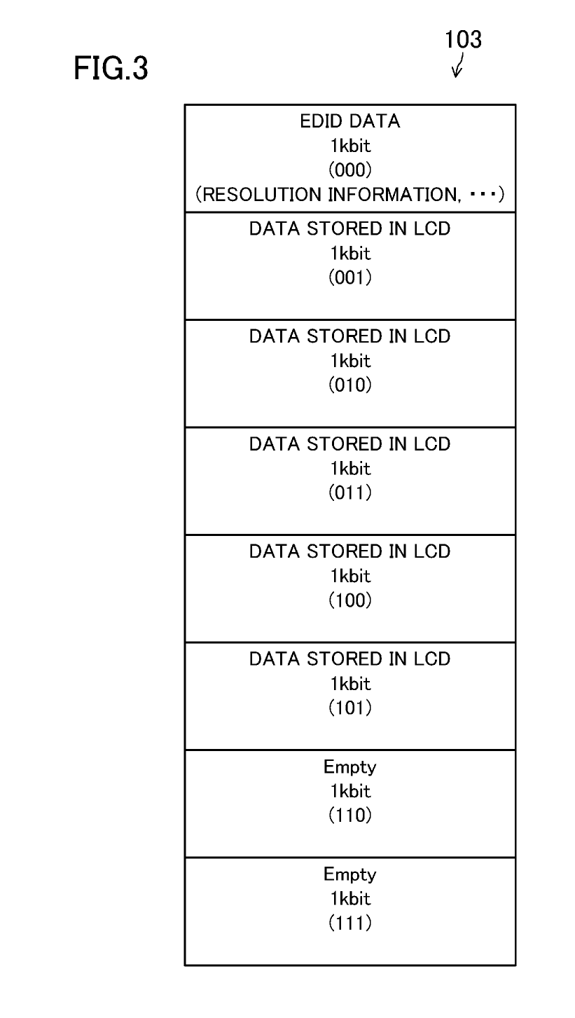

For example, if the resolution information stored in the EEPROM 103 as the EDID data can also be used as data needed for the control processing by the control IC 102, the storage of the data stored in the LCD can be omitted as shown in FIG. 3. Specifically, the control IC 102 and the PC 104 are both connected to the EEPROM 103 via the I2CBUS 106, thereby allowing the control IC 102 to perform access for data stored as the EDID data in the area with, for example, an address (000b). Thus, at least part of data is used in common, thereby reducing the amount of data stored in the EEPROM 103, or reducing the storage capacity of the EEPROM 103.

### Third Embodiment

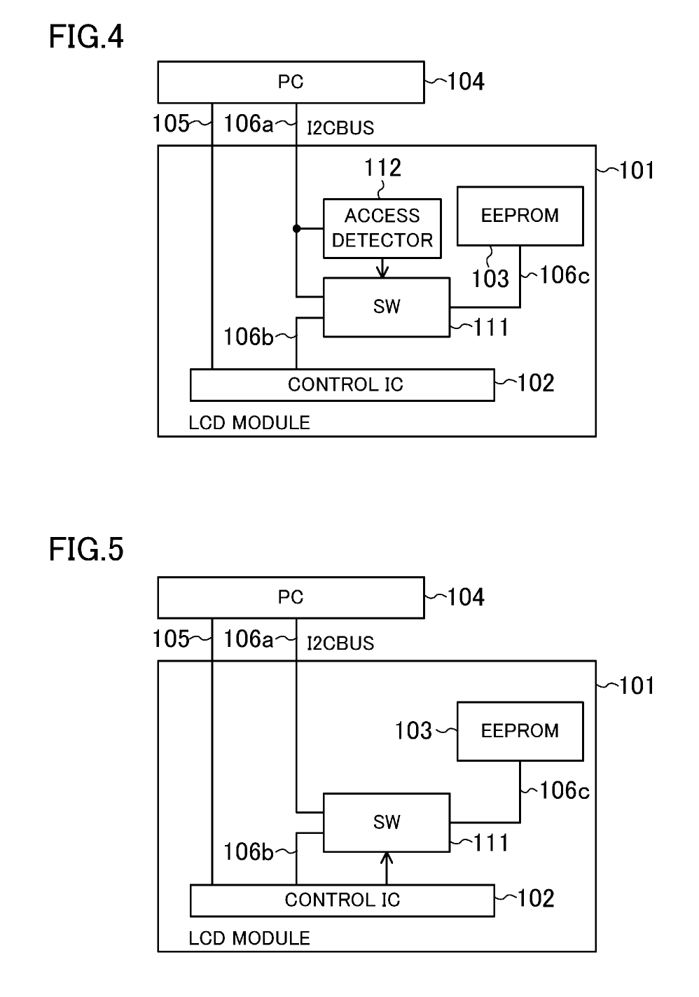

Access competition between the control IC 102 and the PC 104 via the I2CBUS 106 may be produced by an access sequence(s) of one or both of the control IC 102 and the PC 104. In order to more reliably reduce access competition, for example, as shown in FIG. 4, a bus switch 111 may be provided. The switch 111 selectively connects an I2CBUS 106a for an external device or an I2CBUS 106b for an internal device to an I2CBUS 106c for a memory, thereby allowing the PC 104 or the control IC 102 to exclusively access the EEPROM 103. The switching of the switch 111 is controlled by an access detector 112 detecting presence or absence of access from the PC 104. Specifically, when the PC 104 performs access, the I2CBUS 106a for the external device is preferentially connected to the I2CBUS 106c for the memory.

This switching reliably allows the PC 104 to obtain the EDID data.

### Fourth Embodiment

On the other hand, for example, as shown in FIG. 5, the control IC 102 may control the switching of the switch 111. In this case, the control IC 102 reliably preferentially controls the LCD module 101 and accepts access from the PC 104 as long as it does not influence the control.

### Fifth Embodiment

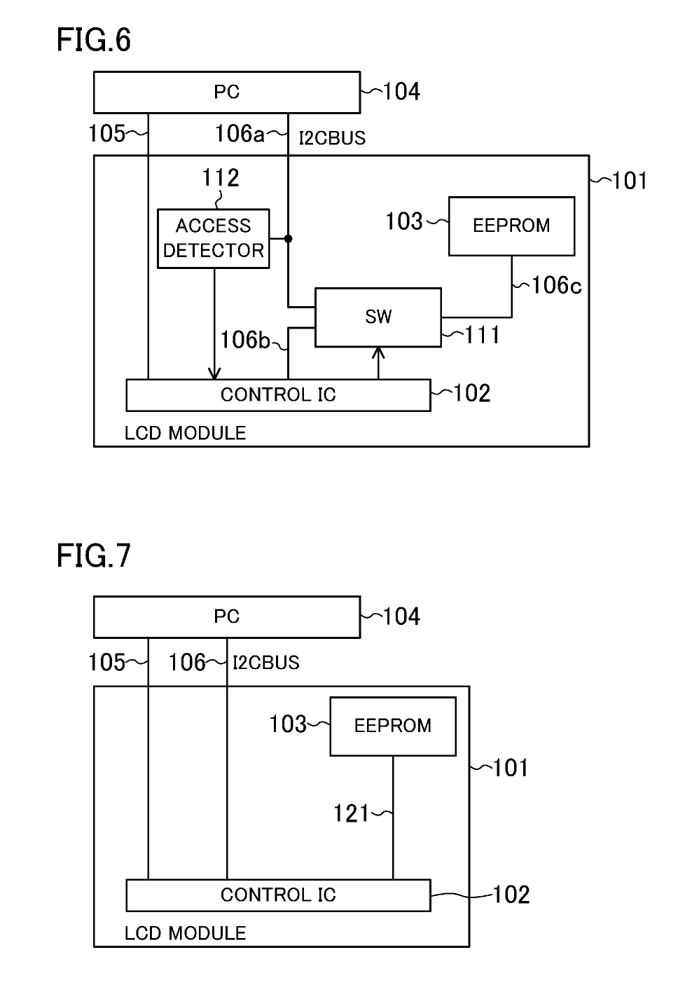

For example, as shown in FIG. 6, the result of the detection by the access detector 112 may be input to the control IC 102, and the control IC 102 controls switching of the switch 111 based on presence or absence of access from the PC 104 and the operational state, etc. of the LCD module 101. In this case, more flexible control such as reduction in the delay of a response to the access from the PC 104 can be easily made, while allowing the control IC 102 to perform proper control operation.

### Sixth Embodiment

Not limited to the direct connection between the PC 104 and the EEPROM 103, as shown in FIG. 7, the connection may be made via the control IC 102. That is, the PC 104 is connected to the control IC 102 via the I2CBUS 106. The control IC 102 is connected to the EEPROM 103 via the I2CBUS or an internal bus 121 in other format.

In order to obtain EDID data, when the PC 104 requests for access like in the direct connection with the EEPROM 103, the control IC 102 reads data corresponding to the request from the EEPROM 103 via the internal bus 121, and transfers the data to the PC 104 via the I2CBUS 106. With this configuration, the EEPROM 103 is used for the EDID data and the data stored in the LCD in common, thereby easily reducing the number of the components forming the LCD module 101.

### INDUSTRIAL APPLICABILITY

As described above, the present invention is useful for display devices, etc. displaying images, etc. in response to image signals input from an external device.

### DESCRIPTION OF REFERENCE CHARACTERS

101 LCD Module
102 Control IC
103 EEPROM
104 PC
105 Image Signal Line
106 I2CBUS
111 Switch
112 Access Detector
121 Internal Bus

1. A display device performing display in response to an image signal input from an external device, the device comprising:
a control circuit configured to control operation of the display device; and
a non-volatile memory configured to store information used for processing by the control circuit, wherein
the non-volatile memory stores specification information on specifications of the display device together with the information used for the processing by the control circuit, and
the specification information is obtained by the external device.

2. The display device of claim 1, wherein
the non-volatile memory is connected to the control circuit, and is connectable to the external device such that the specification information stored in the non-volatile memory is read by access from the external device.

3. The display device of claim 1, wherein
the specification information is stored in a predetermined reserved area of the non-volatile memory determined by a relation with the external device, while the information used for the processing by the control circuit is stored in an area different from the reserved area.

4. The display device of claim 1, wherein
at least part of the specification information is used as the information used for the processing by the control circuit.

5. The display device of claim 1, further comprising:
a switch configured to selectively connect the control circuit or the external device to the non-volatile memory.

6. The display device of claim 5, further comprising:
an access detector configured to detect access from the external device, and control the switch to connect the external device to the non-volatile memory.

7. The display device of claim 5, wherein
switching of the switch is controlled by the control circuit.

8. The display device of claim 7, further comprising:
an access detector configured to detect access from the external device, wherein
the control circuit controls the switch based on a result of detection by the access detector.

9. The display device of claim 1, wherein
the control circuit is connected to the non-volatile memory, and is connectable to the external device to obtain the specification information stored in the non-volatile memory from the external device via the control circuit.
